(19) United States
(12) Patent Application Publication
(10) Pub. No.: US 2025/0386782 A1
(43) Pub. Date: Dec. 25, 2025

(54) CULTIVATION METHOD FOR FRUIT VEGETABLE PLANT, TOMATO, CULTURE SOLUTION FOR HYDROPONIC CULTIVATION OF FRUIT VEGETABLE PLANT, AND HYDROPONIC CULTIVATION DEVICE OF FRUIT VEGETABLE PLANT

(71) Applicant: FUJIFILM CORPORATION, Tokyo (JP)

(72) Inventors: Takafumi HOSOKAWA, Kanagawa (JP); Masao SUGIMOTO, Kanagawa (JP)

(21) Appl. No.: 19/305,784

(22) Filed: Aug. 21, 2025

Related U.S. Application Data
(63) Continuation of application No. PCT/JP2024/006528, filed on Feb. 22, 2024.

(30) Foreign Application Priority Data
Feb. 24, 2023 (JP) 2023-027721

(51) Int. Cl. A01G 31/00; A01G 7/04; A01G 22/05; A01G 31/02

(52) U.S. Cl. CPC A01G 31/011; A01G 7/045; A01G 22/05; A01G 31/024; A01G 31/065

(57) ABSTRACT

Provided are a cultivation method for a fruit vegetable plant including cultivating a fruit vegetable plant by a hydroponic method using a culture solution having a Si content of 60 ppm by mass or more, a tomato, a culture solution for hydroponic cultivation of a fruit vegetable plant, and a hydroponic cultivation device of a fruit vegetable plant.

### CROSS-REFERENCE TO RELATED APPLICATIONS

This application is a continuation application of International Application No. PCT/JP2024/006528, filed on Feb. 22, 2024, the disclosure of which is incorporated herein by reference in its entirety. Further, this application claims priority from Japanese Patent Application No. 2023-027721, filed on Feb. 24, 2023, the disclosure of which is incorporated herein by reference in its entirety.

### BACKGROUND OF THE INVENTION

### 1. Field of the Invention

The present disclosure relates to a cultivation method for a fruit vegetable plant, a tomato, a culture solution for hydroponic cultivation of a fruit vegetable plant, and a hydroponic cultivation device of a fruit vegetable plant.

### 2. Description of the Related Art

Hydroponic cultivation is known as a cultivation method for a fruit vegetable plant such as a tomato. In recent years, a culture solution (for example, seawater) containing sodium chloride or the like has been used in hydroponic cultivation for the purpose of increasing the sugar content of the harvested product.

For example, it is disclosed in JP2004-357638A that, in hydroponic cultivation of tomatoes, a culture solution obtained by diluting seawater is used, in which the seawater has a nitrate nitrogen content of 0.27 mg/liter or more, a silicate content of 3.2 mg/liter or more, a coliform bacteria count of less than 1.8 MPN/100 ml, and a total bacterial count of less than 1/ml.

In addition, it is also disclosed in JP6535421B that seawater is used for hydroponic cultivation of tomatoes as a culture solution.

### SUMMARY OF THE INVENTION

It is known that in a case where the concentration of a salt such as sodium chloride in the raw water of the culture solution used for hydroponic cultivation is high, the salt concentration of the culture solution is high beyond an appropriate range, and the yield decreases. Therefore, there is a demand for improvement of the yield.

An object to be achieved by an embodiment of the present disclosure is to provide a cultivation method for a fruit vegetable plant in which a high yield can be achieved even in a case where a salt such as sodium chloride is contained, a tomato, a culture solution for hydroponic cultivation of a fruit vegetable plant, and a hydroponic cultivation device of a fruit vegetable plant.

Means for solving the above issues include the following aspects.

<1> A cultivation method for a fruit vegetable plant comprising cultivating a fruit vegetable plant by a hydroponic method using a culture solution having a Si content of 60 ppm by mass or more.

<2> The cultivation method for a fruit vegetable plant according to <1>, in which the culture solution contains a silicate.

<3> The cultivation method for a fruit vegetable plant according to <1> or <2>, in which the culture solution contains sodium chloride.

<4> The cultivation method for a fruit vegetable plant according to any one of <1> to <3>, in which an electrical conductivity of the culture solution is 4.0 dS/m or more.

<5> The cultivation method for a fruit vegetable plant according to any one of <1> to <4>, in which the cultivation of the fruit vegetable plant by the hydroponic method is performed at least after planting of a fruit vegetable plant seedling.

<6> The cultivation method for a fruit vegetable plant according to <5>, further comprising irradiating the fruit vegetable plant seedling with artificial light having an intensity of 200 μmol/m²/s to 800 μmol/m²/s.

<7> The cultivation method for a fruit vegetable plant according to <6>, in which the irradiation with the artificial light is performed from at least one of a side surface direction or an upper surface direction of the fruit vegetable plant.

<8> The cultivation method for a fruit vegetable plant according to any one of <1> to <7>, in which the fruit vegetable plant is a tomato or a melon.

<9> The cultivation method for a fruit vegetable plant according to any one of <1> to <8>, in which the fruit vegetable plant is a tomato, and the tomato has a Si content of 20 ppm by mass or more with respect to a dry mass of the tomato.

<10> The cultivation method for a fruit vegetable plant according to any one of <1> to <9>, wherein the fruit vegetable plant is cultivated by a hydroponic method using a culture solution substantially free of Si after planting of a fruit vegetable plant seedling until before flowering at a second fruit cluster level, and after flowering at the second fruit cluster level, the fruit vegetable plant is cultivated by a hydroponic method using a culture solution having a Si content of 60 ppm by mass or more.

<11> A tomato in which a Si content is 20 ppm by mass or more with respect to a dry mass of the tomato, and a Brix sugar content is 5.0% by mass or more.

<12> A culture solution for hydroponic cultivation of a fruit vegetable plant, comprising sodium chloride and a silicate, in which a Si content is 60 ppm by mass or more.

<13> The culture solution for hydroponic cultivation of a fruit vegetable plant according to <12>, in which an electrical conductivity of the culture solution is 4.0 dS/m or more.

<14> A hydroponic cultivation device of a fruit vegetable plant comprising a culture solution tank in which the culture solution for hydroponic cultivation of a fruit vegetable plant according to <12> or <13> is accommodated.

According to an embodiment of the present disclosure, it is possible to provide a cultivation method for a fruit vegetable plant in which a high yield can be achieved even in a case where a salt such as sodium chloride is included, as well as a tomato, a culture solution for hydroponic cultivation of a fruit vegetable plant, and a hydroponic cultivation device of a fruit vegetable plant.

### BRIEF DESCRIPTION OF THE DRAWINGS

FIG. 1 is a schematic cross-sectional view showing an embodiment of a hydroponic cultivation device used in a seedling raising step.

FIG. 2 is a schematic cross-sectional view showing an embodiment of a hydroponic cultivation device of a fruit vegetable plant of the present disclosure.

### DESCRIPTION OF THE PREFERRED EMBODIMENTS

Hereinafter, embodiments for implementing the present disclosure are described in detail. However, the present disclosure is not limited to the following embodiments. In the following embodiments, the components (including elements, steps, and the like) are not essential unless otherwise specified. The same applies to numerical values and ranges thereof, which do not limit the present disclosure.

In the present disclosure, the numerical ranges shown using “to” include the numerical values described before and after “to” as the minimum value and the maximum value.

In a numerical range described in a stepwise manner in the present disclosure, an upper limit or a lower limit described in one numerical range may be replaced with an upper limit or a lower limit in another numerical range described in a stepwise manner. In addition, in a numerical range described in the present disclosure, an upper limit value or a lower limit value described in the numerical range may be replaced with a value described in an example.

In the present disclosure, “mass” and “weight” are synonymous.

In the present disclosure, the term “step” includes not only an independent step but also a step as long as a desired purpose of the step is achieved even in a case where the step cannot be clearly distinguished from other steps.

In the present disclosure, the “fruit vegetable plant” means a plant of which harvested product is a fruit.

In the present disclosure, the “culture solution” means a solution in which nutritional components (for example, inorganic substances, organic substances) required for growth of a plant are dissolved in water or the like.

### [Cultivation Method for Fruit Vegetable Plant]

In the cultivation method for a fruit vegetable plant according to the present disclosure, a fruit vegetable plant is cultivated by a hydroponic method using a culture solution having a Si content of 60 ppm by mass or more (hereinafter, also referred to as a “specific culture solution”). The cultivation using the specific culture solution is preferably performed in the cultivation step after the seedling raising step, may be started either before or after the planting of the fruit vegetable plant after the seedling raising, and is preferably started after the planting of the fruit vegetable plant.

The inventors of the present invention have found that, although the reason is not clear, a high yield can be achieved even in a case where a salt such as sodium chloride is included, by setting the Si content of the culture solution used in the hydroponic method to 60 ppm by mass or more.

In the culture solution disclosed in JP2004-357638A, although the dilution ratio is not described, in a case where seawater is diluted 10 times, which is a general dilution ratio, the Si content is about 0.089 ppm by mass, and it is difficult to improve the yield. In addition, the culture solution disclosed in JP6535421B is seawater, but the Si content is about 0.89 ppm by mass, and it is difficult to improve the yield.

The hydroponic method is not particularly limited, and examples thereof include a Deep Flow Technique hydroponic method, Nutrient Film Technique hydroponic method, aeroponics, and drip hydroponics in which a liquid fertilizer is added dropwise to a root portion or a root portion support.

In the preparation of culture solution, a desired fertilizer composition can be adjusted by appropriately selecting and formulating a single fertilizer. The formulation program “Best Blend” provided by NPO Japan Hydroponic Society may be used for adjusting the fertilizer composition of the culture solution. The component composition of the culture solution can have a target component content by correctly formulating the single fertilizer. In a case of quantifying the components in the culture solution, an ion chromatography method or a high-frequency inductively coupled plasma (ICP) method can be used.

Examples of the fertilizer component of the liquid fertilizer include sodium nitrate, calcium chloride, magnesium chloride, ammonium chloride, potassium sulfate, potassium dihydrogen phosphate, and the like. The liquid fertilizer may be any one of a single fertilizer containing a single fertilizer component as a main component, a compound fertilizer containing two or more components of nitrogen (N), phosphorus (P), and potassium (K), or a blended fertilizer containing a plurality of solid fertilizers blended. It is noted that a required amount of the Si component can also be appropriately added to the blended fertilizer.

The fruit vegetable plant is not particularly limited, and examples thereof include Solanaceae plants such as tomatoes, eggplants, and bell peppers, Cucurbitaceae plants such as melons, cucumbers, pumpkins, and zucchinis, Fabaceae plants such as green beans, peas, and broad beans, Rosaceae plants such as strawberries, Malvaceae plants such as okra, Poaceae plants such as corn, and the like. Among the above-described fruit vegetable plants, the Solanaceae plant or the Cucurbitaceae plant is suitable for the cultivation method according to the present disclosure, and the tomato or the melon is more suitable.

The tomato includes a medium size tomato, a cherry tomato, a high-sugar tomato, and the like. In addition, the melon includes netted melons such as green flesh and orange flesh, and non-netted melons.

The lower limit of the Si content in the specific culture solution may be 70 ppm by mass or more or may be 80 ppm by mass or more.

From the viewpoint of the uniformity of the culture solution, the upper limit of the Si content in the specific culture solution is preferably 300 ppm by mass or less, more preferably 200 ppm by mass or less, and still more preferably 100 ppm by mass or less.

In the present disclosure, the Si content in the culture solution means the Si content with respect to the total mass of the culture solution.

In the present disclosure, the Si content in the culture solution is measured by an inductively coupled plasma optical emission spectrometer (ICP-OES).

The adjustment of the Si content of the culture solution can be performed, for example, by adding sodium silicate or the like to the culture solution.

From the viewpoint of improving the yield, the specific culture solution preferably contains a silicate. As the silicate, sodium silicate is preferable from the viewpoint of improving the yield.

The content of sodium silicate with respect to the total mass of the specific culture solution is not particularly limited as long as the Si content is 60 ppm by mass or more. In a case where the pH is increased beyond the preferred range as a result of adding the target amount of sodium silicate, it is preferable to adjust the pH using dilute hydrochloric acid or the like.

From the viewpoint of increasing the sugar content, the specific culture solution preferably contains sodium chloride.

From the viewpoint of increasing the sugar content, sodium chloride is preferably added to the culture solution in an amount such that the electrical conductivity of the specific culture solution is 4.0 dS/m or more, sodium chloride is more preferably added to the culture solution in an amount such that the electrical conductivity of the specific culture solution is 4.5 dS/m or more, and sodium chloride is still more preferably added to the culture solution in an amount such that the electrical conductivity of the specific culture solution is 6.0 dS/m or more.

From the viewpoint of improving the yield, the upper limit of the electrical conductivity of the specific culture solution is preferably 20.0 dS/m or less, more preferably 10.0 dS/m or less, and still more preferably 8.0 dS/m or less.

In the present disclosure, the measurement of the electrical conductivity in the culture solution is performed in a culture solution at 25° C. using an electrical conductivity meter (for example, HI98131 manufactured by Hanna Instruments, Inc.).

The dissolved oxygen concentration of the specific culture solution is preferably 3.5 mg/l or more, more preferably 4.5 mg/l or more, and even more preferably 6.0 mg/l or more.

In addition, the upper limit value of the dissolved oxygen concentration of the specific culture solution is not particularly limited. The higher it is, the more preferable it is, and it is preferable to set it to a saturated concentration at the temperature of the culture solution to be used. For example, at 1 atm, a saturated dissolved oxygen concentration of distilled water at 27° C. is 7.87 mg/l.

In the present disclosure, the dissolved oxygen concentration of the culture solution is measured in the culture solution at 27° C. by using an oxygen concentration monitor device (for example, Seven2Go Pro manufactured by Mettler-Toledo International Inc.).

The oxygen concentration monitor device can be disposed and used in a culture solution tank in which the culture solution is accommodated.

The dissolved oxygen concentration of the culture solution can be adjusted by using an oxygen supply mechanism, adjusting the circulation rate of the culture solution, or the like.

The pH of the specific culture solution is preferably 3.5 to 8.0 and more preferably 4.5 to 7.0.

The pH of the culture solution is measured in the culture solution at 27° C. by using a pH monitor device (for example, HI98131 manufactured by Hanna Instruments).

The pH of the culture solution can be adjusted, for example, by adding hydrochloric acid, sodium hydroxide, or the like to the culture solution.

The cultivation of a fruit vegetable plant by a hydroponic method using a specific culture solution may be performed before or after the planting of a fruit vegetable plant seedling, or before and after the planting of a fruit vegetable plant seedling, from the viewpoints of improving the yield, increasing the sugar content, and the like, and it is preferable to perform at least after the planting of a fruit vegetable plant seedling. The cultivation step will be described later. In addition, from the viewpoint of increasing the sugar content, the cultivation of the fruit vegetable plant by the hydroponic method using the specific culture solution is preferably performed after the planting of the fruit vegetable plant seedlings and after the flowering at the second fruit cluster level.

In the step of raising the germinated fruit vegetable plant into the fruit vegetable plant seedling (seedling raising step), from the viewpoint of cultivation efficiency, it is preferable to use a culture solution other than the specific culture solution, that is, a culture solution having a Si content of less than 60 ppm by mass, more preferable to use a culture solution having a Si content of less than 30 ppm by mass, and still more preferable to use a culture solution having a Si content of less than 3 ppm by mass.

### —Cultivation Step—

The cultivation method for a fruit vegetable plant of the present disclosure can include a cultivation step. In the cultivation step, the fruit vegetable plant seedlings are planted and cultivated.

From the viewpoints of improving the yield, increasing the sugar content, and the like, in the cultivation step, it is preferable that the cultivation of the fruit vegetable plant by the hydroponic method using the specific culture solution is performed at least after the flowering of the second fruit cluster level.

In the cultivation step, the temperature conditions can be adjusted by the artificial light with which the fruit vegetable plant seedling is irradiated. For example, the temperature can be adjusted to two or more temperature conditions of the light period temperature and the dark period temperature.

From the viewpoints of cultivation efficiency, increasing the sugar content, and the like, the upper limit of the light period temperature is preferably 29° C. or lower, more preferably 28.5° C. or lower, and still more preferably 28° C. or lower.

From the viewpoints of cultivation efficiency, increasing the sugar content, and the like, the lower limit of the light period temperature is preferably 15° C. or higher, more preferably 20° C. or higher, and still more preferably 25° C. or higher.

From the viewpoints of cultivation efficiency, increasing the sugar content, and the like, the upper limit of the dark period temperature is preferably 25° C. or lower, more preferably 23° C. or lower, and still more preferably 22° C. or lower.

From the viewpoints of cultivation efficiency, increasing the sugar content, and the like, the lower limit of the dark period temperature is preferably 10° C. or higher, more preferably 13° C. or higher, and still more preferably 15° C. or higher.

The light period temperature and the dark period temperature are measured by placing a thermometer at a position 1 cm away from the fruit vegetable plant. As the thermometer, for example, a temperature/humidity sensor THA-3151 manufactured by T&D Corporation can be used.

In the present disclosure, the “light period” means a period during which the fruit vegetable plant is subjected to irradiation by the light source. In addition, in the present disclosure, the “dark period” means a period during which the fruit vegetable plant is not subjected to irradiation by the light source.

A method of controlling the light period temperature and the dark period temperature is not particularly limited and the light period temperature and the dark period temperature can be controlled by using a known method in the related art. For example, the controlling of the light period temperature and the dark period temperature can be performed by monitoring the light period temperature and the dark period temperature of the seedling raising environment with the above-described thermometer, and sending hot air or cold air as necessary.

From the viewpoints of cultivation efficiency, increasing the sugar content, and the like, a ratio of the time of the light period to the time of the dark period (time of light period/time of dark period) is preferably 0.3 to 3 and more preferably 0.5 to 2.

The light source of the artificial light is not particularly limited, and examples thereof include semiconductor light sources such as a light emitting diode (LED), discharge lamps such as a fluorescent lamp, and the like. In the cultivation method for a fruit vegetable plant according to the present disclosure, it is preferable to use LEDs.

One type of LED may be used, or two or more types of LEDs may be used.

The LED may emit visible light such as red, blue, and yellow, or may emit invisible light of ultraviolet light (wavelength of 380 nm or less) or infrared light (wavelength of 780 nm or more). However, from a viewpoint of promoting photosynthesis of the fruit vegetable plant, the LED preferably emits light in a wavelength range of 400 nm to 700 nm.

From the viewpoints of cultivation efficiency, increasing the sugar content, and the like, the relative humidity in the cultivation step is preferably controlled within a range of 50% to 80%, and more preferably controlled within a range of 55% to 77%.

The relative humidity is measured by placing a hygrometer at a position 1 cm away from the fruit vegetable plant. As the hygrometer, for example, a temperature/humidity sensor THA-3151 manufactured by T&D Corporation can be used.

A method of controlling the humidity is not particularly limited, and the humidity can be controlled by a known method in the related art. For example, the humidity condition can be controlled by monitoring the humidity of the seedling raising environment with the above hygrometer and using, as necessary, an air conditioning device having a humidifying function and a dehumidifying function.

From the viewpoints of cultivation efficiency, increasing the sugar content, and the like, the intensity of the artificial light irradiated onto the fruit vegetable plant seedling in the cultivation step is preferably 200 μmol/m²/s to 800 μmol/m²/s, and more preferably 250 μmol/m²/s to 600 μmol/m²/s.

The intensity of light is measured by placing a light-receiving surface of a measuring instrument toward the light source at a position 1 cm away from the fruit vegetable plant. As the measuring instrument, for example, a quantum sensor (LI-190R, manufactured by LI-COR, Inc.) and the like can be used. In a case where the light sources are disposed in two or more directions from the fruit vegetable plant after germination, the sum of the light intensities measured by disposing the measuring instrument toward respective light sources is defined as the light intensity.

The intensity of light can be controlled by changing a type, the number, or the like of the light source (LED, fluorescent lamp, or the like) used, changing the distance between the light source and the fruit vegetable plant, or using a dimmable light source.

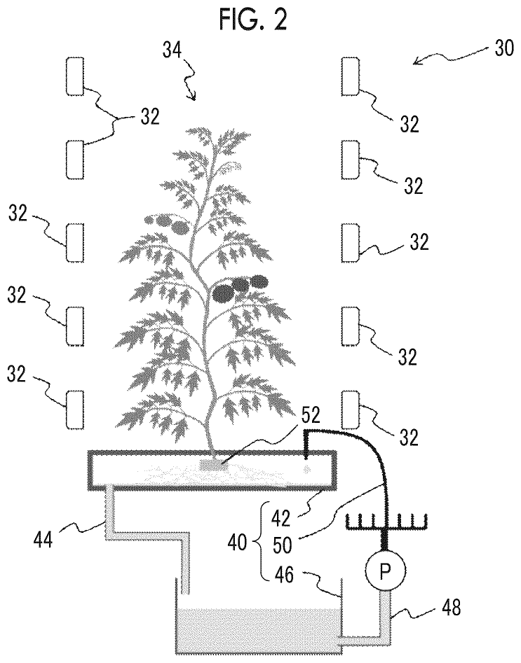

In the cultivation step, for example, the cultivation can be performed using the hydroponic cultivation device of a fruit vegetable plant shown in FIG. 2. Details of the hydroponic cultivation device of a fruit vegetable plant will be described later.

The irradiation with artificial light may be performed from the upper surface direction of the fruit vegetable plant seedling or from the side surface direction thereof, but from the viewpoints of cultivation efficiency, space utilization efficiency, and the like, it is preferable to perform the irradiation from the side surface direction.

In addition, the irradiation with the artificial light may be performed from both the side surface direction and the upper surface direction.

In the cultivation step, from the viewpoint of shortening the period until harvesting, the carbon dioxide concentration in the environment is preferably 300 ppm to 2,000 ppm, and more preferably 400 ppm to 1,500 ppm.

The carbon dioxide concentration is measured by placing a carbon dioxide meter at a position 1 cm away from the fruit vegetable plant. As the carbon dioxide meter, for example, LI-850 manufactured by LI-COR, Inc. can be used.

The method of controlling the carbon dioxide concentration is not particularly limited, and the carbon dioxide concentration can be controlled by a known method in the related art. For example, the carbon dioxide concentration can be controlled by monitoring the carbon dioxide concentration in the environment with the above-described carbon dioxide meter and using a CO₂ supply system or the like, as necessary.

The period of the cultivation step is not particularly limited, but is preferably 70 days to 300 days, more preferably 80 days to 200 days, still more preferably 80 days to 150 days, and particularly preferably 90 days to 120 days.

In the period of the cultivation step, it is preferable to perform replacement of the nutrient solution, addition of the liquid fertilizer, and the like as necessary, depending on the EC value, pH, and the like of the nutrient solution.

In the cultivation step, it is preferable to remove the leaves below the fruit cluster level at which the harvest of the fruit has been completed. By removing the leaves below the fruit cluster level in which the harvest of the fruit has been completed, the cultivation efficiency can be improved.

The lateral buds of the fruit vegetable plant may be appropriately removed (lateral bud picking).

### —Seedling Raising Step—

The cultivation method for a fruit vegetable plant of the present disclosure can include a seedling raising step. In the seedling raising step, a fruit vegetable plant after germination is raised as a fruit vegetable plant seedling.

From the viewpoint of cultivation efficiency, seedling raising of the fruit vegetable plant is preferably performed by a hydroponic method, and more preferably performed by a Deep Flow Technique hydroponic method.

From the viewpoint of cultivation efficiency, in the seedling raising step, it is preferable to use a culture solution other than the specific culture solution, that is, a culture solution having a Si content of less than 60 ppm by mass, it is more preferable to use a culture solution having a Si content of less than 30 ppm by mass, and it is still more preferable to use a culture solution having a Si content of less than 3 ppm by mass.

In the seedling raising step, the light period and the dark period can be switched by irradiating the fruit vegetable plant after germination with artificial light, and it is preferable that the temperature conditions be adjusted between the light period and the dark period. For example, the temperature can be adjusted to two or more temperature conditions of the light period temperature and the dark period temperature.

From the viewpoint of shortening the period until budding, the upper limit of the light period temperature is preferably 29° C. or lower, more preferably 28.5° C. or lower, and still more preferably 28° C. or lower.

From the viewpoint of shortening the period until budding, the lower limit of the light period temperature is preferably 15° C. or higher, more preferably 20° C. or higher, and still more preferably 25° C. or higher.

From the viewpoint of shortening the period until budding, the upper limit of the dark period temperature is preferably 25° C. or lower, more preferably 23° C. or lower, and still more preferably 22° C. or lower.

From the viewpoint of shortening the period until budding, the lower limit of the dark period temperature is preferably 10° C. or higher, more preferably 13° C. or higher, and still more preferably 15° C. or higher.

The light source, wavelength, and the like of the artificial light can be used as described in the cultivation step.

From the viewpoints of cultivation efficiency, increasing the sugar content, and the like, a ratio of the time of the light period to the time of the dark period (time of light period/time of dark period) is preferably 0.3 to 3 and more preferably 0.5 to 2.

From the viewpoints of cultivation efficiency, increasing the sugar content, and the like, the relative humidity in the seedling raising step is preferably controlled within a range of 50% to 80%, and more preferably controlled within a range of 55% to 77%.

From the viewpoints of cultivation efficiency, increasing the sugar content, and the like, the intensity of the artificial light irradiated onto the fruit vegetable plant after germination in the seedling raising step is preferably 200 μmol/m²/s to 800 μmol/m²/s, and more preferably 250 μmol/m²/s to 600 μmol/m²/s.

The irradiation with artificial light may be performed from the upper surface direction of the fruit vegetable plant after germination or from the side surface direction thereof, but from the viewpoints of cultivation efficiency, space utilization efficiency, and the like, it is preferable to perform the irradiation from the upper surface direction.

In addition, the irradiation with the artificial light may be performed from both the side surface direction and the upper surface direction.

In the seedling raising step, from the viewpoint of shortening the period until harvesting, the carbon dioxide concentration in the environment is preferably 300 ppm to 2,000 ppm, and more preferably 400 ppm to 1,500 ppm.

The period of the seedling raising step is not particularly limited, and from the viewpoints of growth potential after planting, shortening of the period until budding, and the like, the seedling raising period is preferably 5 days to 40 days, more preferably 10 days to 35 days, still more preferably 12 days to 30 days, and particularly preferably 15 days to 33 days.

In the period of the seedling raising step, it is preferable to perform replacement of the nutrient solution, addition of the liquid fertilizer, and the like as necessary, depending on the EC value, pH, and the like of the nutrient solution.

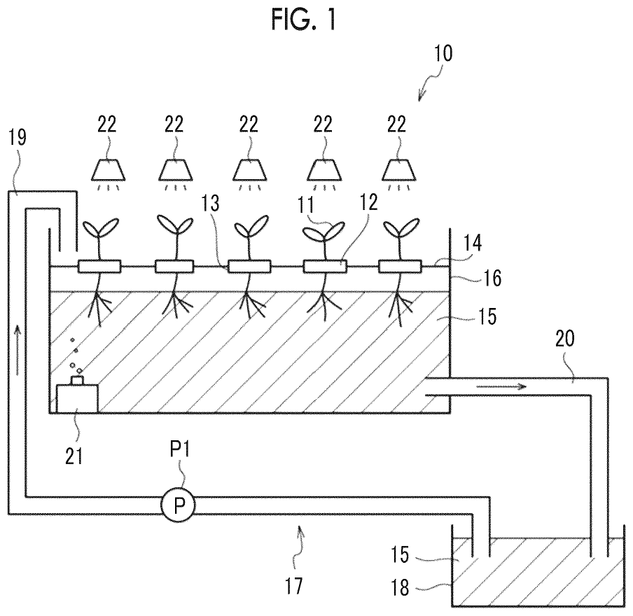

In the seedling raising step, seedlings can be raised using the hydroponic cultivation device shown in FIG. 1. FIG. 1 is a schematic cross-sectional view showing an embodiment of a hydroponic cultivation device.

As shown in FIG. 1, a hydroponic cultivation device of a fruit vegetable plant 10 can include a support 12 that supports a fruit vegetable plant seedling 11, a panel 14 having a hole 13 for fixing the support 12, and a culture solution tank 16 that accommodates a culture solution 15.

In addition, the hydroponic cultivation device of a fruit vegetable plant 10 can include a circulation mechanism 17 that supplies the culture solution 15 to the culture solution tank 16 and discharges the culture solution 15 from the culture solution tank 16.

Furthermore, the circulation mechanism 17 can include a circulation tank 18 in which the culture solution 15 is accommodated, a supply nozzle 19 that supplies the culture solution 15 from the circulation tank 18 to the culture solution tank 16, a discharge nozzle 20 that discharges the culture solution 15 from the culture solution tank 16 to the circulation tank 18, and a pump P1.

In addition, the hydroponic cultivation device of a fruit vegetable plant 10 can include the oxygen supply mechanism 21 in the culture solution tank 16.

In addition, the hydroponic cultivation device of a fruit vegetable plant 10 can include the artificial light irradiation device 22. In FIG. 1, the artificial light irradiation device that irradiates the fruit vegetable plant seedling 11 with artificial light in the upper surface direction and the side surface direction is shown, but the present invention is not limited thereto.

### —Germination Step—

The cultivation method for a fruit vegetable plant of the present disclosure can include a germination step. In the germination step, the seeds of the fruit vegetable plant used in the seedling raising step are germinated.

A germination method is not particularly limited, and the germination can be performed by a known method in the related art. For example, the germination can be carried out by seeding seeds of a fruit vegetable plant on the above-described support sufficiently wetted with water and storing in a dark place.

In addition, it is preferable to select fruit vegetable plants having a similar degree of growth from among the seeds of the fruit vegetable plants in which germination is confirmed and to carry out raising seedlings. Accordingly, the harvesting time of the fruit can be matched, and the cultivation efficiency can be improved.

The temperature in the germination step varies depending on the item and variety of the fruit vegetable plant to be used, but in a case of commercially available seeds, these are generally disclosed as the germination temperature. In addition, in a case where the germination temperature is unknown, it can be experimentally confirmed. Furthermore, depending on the item and variety of the fruit vegetable plant to be used, it may be necessary to perform a treatment such as dormancy breaking during germination. In the germination process, there are those that require light of a specific wavelength, those that require to be under darkness, and those germinates in any of the cases. These can be also known in the same manner as the germination temperature.

The relative humidity in the germination process is preferably 70% to 100% and particularly preferably 80% to 95%. By setting the relative humidity to this range, it is possible to prevent drying of a plant body in the germination period and to make the growth good.

The period required for the germination process is not determined to be constant, but it is preferably a period until rooting and subsequent hypocotyl elongation start, generally about several days to one week. By applying this period to the germination process, the roots can be sufficiently grown, and at the same time, it is possible to avoid excessive hypocotyl elongation. Therefore, the growth of seedlings in the subsequent seedling raising process is made good and a period until flowering can be shortened, which is preferable.

In an embodiment of the cultivation method for a fruit vegetable plant of the present disclosure, the fruit vegetable plant is a tomato. From the viewpoint of increasing the added value of the tomato, the Si content with respect to the dry mass of the tomato harvested by the cultivation method for a fruit vegetable plant according to the present disclosure is preferably 20 ppm by mass or more, more preferably 25 ppm by mass or more, and still more preferably 28 ppm by mass or more.

In the present disclosure, the Si content with respect to the dry mass of the tomato is measured by a fluorescence X-ray analysis method using a pulverized and dried tomato fruit as a sample.

The ranges and preferred aspects of the Brix sugar content and the lycopene content of the tomato of the present disclosure will be described later.

### [Tomato]

In a tomato according to the present disclosure, a Si content is 20 ppm by mass or more with respect to a dry mass of the tomato, and a Brix sugar content is 5.0% by mass or more.

The tomato according to the present disclosure can be cultivated by the above-described cultivation method for a fruit vegetable plant according to the present disclosure. In addition, in the cultivation of the tomato, a culture solution for hydroponic cultivation of a fruit vegetable plant and a hydroponic cultivation device of a fruit vegetable plant, which will be described later, may be used.

From the viewpoint of increasing the added value of the tomato, the Si content with respect to the dry mass of the tomato is preferably high, more preferably 25 ppm by mass or more, and still more preferably 28 ppm by mass or more.

### —Brix Sugar Content—

The Brix sugar content of the tomato is preferably 5.0% by mass or more, more preferably 5.5% by mass or more, still more preferably 6.0% by mass or more, and particularly preferably 7.0% by mass or more.

In the present disclosure, the “Brix sugar content” refers to a value in which a refractive index measured at 20° C. using a sugar content meter or a refractometer is converted into % by mass of a sucrose solution based on a conversion table of the International Commission for Uniform Methods of Sugar Analysis (ICUMSA). For example, in a case where a solution of 100 g contains x g of sucrose (water=100−x g), the Brix sugar content is x %.

In the present disclosure, the Brix sugar content of the tomato is measured by a sugar content measuring instrument (sugar content meter manufactured by Atago Co., Ltd.) after cutting the tomato in half along any plane in the longitudinal direction (that is, direction orthogonal to the equatorial plane) of the tomato, crushing one of the halves into a liquid, and using the obtained liquid.

### —Lycopene Content—

The lycopene content of the tomato is preferably 10 mg/100 g or more, more preferably 12 mg/100 g or more, and still more preferably 15 mg/100 g or more.

In the present disclosure, the lycopene content of the tomato is measured by an absolute calibration curve method using a high-performance liquid chromatograph.

### [Culture Solution for Hydroponic Cultivation of Fruit Vegetable Plant]

The culture solution for hydroponic cultivation of a fruit vegetable plant according to the present disclosure contains sodium chloride and silicate, and has a Si content of 60 ppm by mass or more. The details of the Si content are as described above, and thus the description thereof will be omitted here.

The culture solution for hydroponic cultivation of a fruit vegetable plant according to the present disclosure can be used in the cultivation method for a fruit vegetable plant according to the present disclosure described above.

Since the preferred aspect of the culture solution for hydroponic cultivation of fruit vegetable plants is the same as the preferred aspect of the specific culture solution, the description thereof will be omitted here.

### [Hydroponic Cultivation Device of Fruit Vegetable Plant]

The hydroponic cultivation device of a fruit vegetable plant according to the present disclosure includes a culture solution tank in which a culture solution for hydroponic cultivation of a fruit vegetable plant (specific culture solution) is accommodated.

The hydroponic cultivation device of a fruit vegetable plant according to the present disclosure can include an artificial light irradiation device.

In a case of cultivating a fruit vegetable plant by a hydroponic method using a specific culture solution, cultivation can be performed, for example, using the hydroponic cultivation device shown in FIG. 2, as the hydroponic cultivation device for performing cultivation using the specific culture solution, after planting a fruit vegetable plant seedling. FIG. 2 is a schematic cross-sectional view showing an embodiment of a hydroponic cultivation device of a fruit vegetable plant of the present disclosure.

An embodiment of the hydroponic cultivation device of a fruit vegetable plant according to the present disclosure will be described with reference to FIG. 2.

A hydroponic cultivation device of a fruit vegetable plant 30 shown in FIG. 2 is a cultivation device including an LED lighting device 32 which is an artificial light irradiation device, a drip hydroponic system 40, and a temperature and humidity control system (not shown).

The LED lighting device 32 includes an LED light source, and five LED lighting devices 32 are disposed on one side of the plant body 34 (that is, a total of 10 LED lighting devices 32 on both sides) at intervals of 20 cm along a direction parallel to the direction of gravitational force on both side surfaces of the plant body 34. Accordingly, the plant body 34 can be irradiated with light from a side surface direction of the plant body.

The drip hydroponic system 40 includes a culture solution tank 42, a culture solution storage tank 46, and a drip pipe 50.

The culture solution tank 42 accommodates a culture solution for immersing the root portion of the plant body 34, and the accommodated culture solution is sucked from the root portion to the plant body. One end of a discharge pipe 44 for discharging the accommodated culture solution is connected to the culture solution tank 42. In addition, a panel (not shown) having a hole portion for fixing the support 52 is attached to the culture solution tank 42, and the plant body 34 is supported by the support 52 fixed to the hole portion. Here, a urethane support which is an example of the support is disposed. The urethane support may be one that remains from that used at the time of seeding.

The culture solution storage tank 46 includes a supply pipe 48, and stores a culture solution to be supplied to the culture solution tank 42. The other end of the discharge pipe 44 connected to the culture solution tank 42 is disposed above the liquid surface of the culture solution in the culture solution storage tank 46, and the culture solution is returned to the culture solution storage tank 46 from the other end of the discharge pipe 44 in accordance with the supply of the culture solution from the supply pipe 48.

The supply pipe 48 includes a drive pump P, and the culture solution stored in the culture solution storage tank 46 can be supplied to the outside by driving the drive pump P.

The drip pipe 50 includes a drip device at a tip part thereof and is connected to one end of the supply pipe 48. In a case where the drive pump P is driven, the culture solution is sent to the drip device at the tip part through the supply pipe 48, and the culture solution is supplied dropwise from the drip device to the culture solution tank 42.

In the drip hydroponic system 40, a circulation system is constructed by connecting the culture solution tank 42, the culture solution storage tank 46, and the drip pipe 50, and the culture solution is circulated and can be used.

As the temperature and humidity control system, for example, a temperature and humidity meter (may be a thermometer and a hygrometer) that can measure temperature and humidity, and a heating and cooling device, a humidifier, and the like that take in a signal of the measured temperature and humidity and adjust the temperature and humidity can be used.

### EXAMPLES

Hereinafter, embodiments will be specifically described with reference to Examples, but the embodiments are not limited to these Examples.

### <Preparation of Culture Solutions for Hydroponic Cultivation of a Fruit Vegetable Plant a to D, N, and P to R>

A sodium silicate aqueous solution and dilute hydrochloric acid were added to the single fertilizer to prepare a culture solution A for hydroponic cultivation of a fruit vegetable plant, having a pH of 5.

A sodium silicate aqueous solution and dilute hydrochloric acid were added to the single fertilizer to prepare a culture solution B for hydroponic cultivation of a fruit vegetable plant, having a pH of 5.

A sodium silicate aqueous solution, sodium chloride, and dilute hydrochloric acid were added to the single fertilizer to prepare a culture solution C for hydroponic cultivation of a fruit vegetable plant, having a pH of 5.

A sodium silicate aqueous solution, sodium chloride, and dilute hydrochloric acid were added to the single fertilizer to prepare a culture solution D for hydroponic cultivation of a fruit vegetable plant, having a pH of 5.

Diluted hydrochloric acid was added to the single fertilizer to prepare a culture solution N for hydroponic cultivation of a fruit vegetable plant, having a pH of 5.

A sodium silicate aqueous solution, sodium chloride, and dilute hydrochloric acid were added to the single fertilizer to prepare a culture solution P for hydroponic cultivation of a fruit vegetable plant, having a pH of 5.

Sodium chloride and dilute hydrochloric acid were added to the single fertilizer to prepare a culture solution Q for hydroponic cultivation of a fruit vegetable plant, having a pH of 5.

Sodium chloride and dilute hydrochloric acid were added to the single fertilizer to prepare a culture solution R for hydroponic cultivation of a fruit vegetable plant, having a pH of 5.

The compositions of the culture solutions for hydroponic cultivation of a fruit vegetable plant are summarized in Table 1.

TABLE 1

| Culture | Si | NO₃⁻ | K⁺ | PO₄³⁻ | Ca²⁺ | SO₄²⁻ | Mg²⁺ | Mo |
|---|---|---|---|---|---|---|---|---|
| solution | Concen- | Concen- | Concen- | Concen- | Concen- | Concen- | Concen- | Concen- |
| for hydroponic | tration | tration | tration | tration | tration | tration | tration | tration |
| cultivation of fruit | [ppm | [ppm | [ppm | [ppm | [ppm | [ppm | [ppm | [ppm |
| vegetable plant | by mass] | by mass] | by mass] | by mass] | by mass] | by mass] | by mass] | by mass] |
| A | 60 | 430 | 177 | 100 | 90 | 76 | 25 | 30 |
| B | 300 | 430 | 177 | 100 | 90 | 76 | 25 | 30 |
| C | 92 | 430 | 177 | 100 | 90 | 76 | 25 | 30 |
| D | 92 | 430 | 177 | 100 | 90 | 76 | 25 | 30 |
| N | 0 | 430 | 177 | 100 | 90 | 76 | 25 | 30 |
| P | 56 | 430 | 177 | 100 | 90 | 76 | 25 | 30 |
| Q | 0 | 430 | 177 | 100 | 90 | 76 | 25 | 30 |
| R | 0 | 430 | 177 | 100 | 90 | 76 | 25 | 30 |

| Culture | Zn | Fe | Cu | B | Mn | Ni | |
|---|---|---|---|---|---|---|---|
| solution | Concen- | Concen- | Concen- | Concen- | Concen- | Concen- | Electrical |
| for hydroponic | tration | tration | tration | tration | tration | tration | conduc- |
| cultivation of fruit | [ppm | [ppm | [ppm | [ppm | [ppm | [ppm | tivity |
| vegetable plant | by mass] | by mass] | by mass] | by mass] | by mass] | by mass] | [dS/m] |
| A | 150 | 1,750 | 80 | 350 | 560 | 50 | 2.5 |
| B | 150 | 1,750 | 80 | 350 | 560 | 50 | 3.6 |
| C | 150 | 1,750 | 80 | 350 | 560 | 50 | 4.9 |
| D | 150 | 1,750 | 80 | 350 | 560 | 50 | 8.2 |
| N | 150 | 1,750 | 80 | 350 | 560 | 50 | 2.2 |
| P | 150 | 1,750 | 80 | 350 | 560 | 50 | 2.5 |
| Q | 150 | 1,750 | 80 | 350 | 560 | 50 | 4.9 |
| R | 150 | 1,750 | 80 | 350 | 560 | 50 | 8.2 |

### Example 1

### (Germination Step)

Tomato seeds (variety: Momotaro York (registered trademark), manufactured by TAKII & Co., Ltd) were sown on a support A (5 cm×5 cm×2 cm foamed polyurethane) sufficiently containing pure water, stored for 3 days in a dark environment at a temperature of 28° C. and a relative humidity of 70%, and germinated to obtain a tomato plant body.

### (Seedling Raising Step)

The tomato plant body obtained in the above-described germination step was transplanted to a hydroponic cultivation device shown in FIG. 1 that includes an artificial light irradiation device and a culture solution tank in which the culture solution N for hydroponic cultivation of a fruit vegetable plant was accommodated, and raised seedlings for 20 days by a Deep Flow Technique hydroponic method.

### (Cultivation Step)

For the obtained 40 plant bodies, cultivation was started under the following condition 1 in the hydroponic cultivation device of a fruit vegetable plant shown in FIG. 2. The hydroponic cultivation device of a fruit vegetable plant shown in FIG. 2 is a cultivation device including five light sources disposed on both side surfaces of a plant body (that is, a total of ten light sources on both sides) at an interval of 20 cm in a direction of gravitational force, a drip hydroponic system, and a temperature and humidity control system. During the cultivation period, the pinching, the thinning, and the harvesting were performed by the method described in paragraph 0058 of WO2022/102328A, and after three flower clusters (first to third flower clusters) set on the main branch, it was confirmed that two main leaves were developed on an upper side of the third flower cluster, and then pinching was performed while leaving the main leaves.

Each fruit cluster was thinned such that the number of fruit setting per cluster was 3, the tomato fruits born up to the third flower cluster were harvested, and cultivation was completed.

### [Condition 1]

Light source: plant growth LED four-color type, PGL-200DWB26D, manufactured by Ryoden Corporation
Intensity of light: 500 μmol/m²·s
Light composition: in accordance with light emission behavior of the LED.
Light-dark cycle (light period/dark period): 16 hours/8 hours
Temperature: 27° C. (light period), 19° C. (dark period)
Relative humidity: 60%
Carbon dioxide concentration: 1,000 ppm
Culture solution for hydroponic cultivation of fruit vegetable plant: A
Fertilization method: drip hydroponics

### Example 2

A fruit vegetable plant was cultivated in the same manner as in Example 1, except that the culture solution A for hydroponic cultivation of a fruit vegetable plant used in the cultivation was changed to the culture solution B for hydroponic cultivation of a fruit vegetable plant.

### Example 3

A fruit vegetable plant was cultivated in the same manner as in Example 1, except that the cultivation was started under the following condition 2, and at a time when the flowering in the second flower cluster level was confirmed, the culture solution N for hydroponic cultivation of a fruit vegetable plant was changed to the culture solution C for hydroponic cultivation of a fruit vegetable plant.

### [Condition 2]

Light-dark cycle: 16 hours (light)/8 hours (dark)
Light intensity: 500 μmol/m².s
Temperature: 27° C. (light)/19° C. (dark)
Relative humidity: 70%
CO₂ concentration: 1,000 ppm
Culture solution for hydroponic cultivation of fruit vegetable plant: N

### Example 4

A fruit vegetable plant was cultivated in the same manner as in Example 3, except that the culture solution C for hydroponic cultivation of a fruit vegetable plant used in the cultivation was changed to the culture solution D for hydroponic cultivation of a fruit vegetable plant.

### Comparative Example 1

A fruit vegetable plant was cultivated in the same manner as in Example 1, except that the culture solution A for hydroponic cultivation of a fruit vegetable plant used in the cultivation was changed to the culture solution N for hydroponic cultivation of a fruit vegetable plant.

### Comparative Example 2

A fruit vegetable plant was cultivated in the same manner as in Example 1, except that the culture solution A for hydroponic cultivation of a fruit vegetable plant used in the cultivation was changed to the culture solution P for hydroponic cultivation of a fruit vegetable plant.

### Comparative Example 3

A fruit vegetable plant was cultivated in the same manner as in Example 3, except that the culture solution C for hydroponic cultivation of a fruit vegetable plant used in the cultivation was changed to the culture solution Q for hydroponic cultivation of a fruit vegetable plant.

### Comparative Example 4

A fruit vegetable plant was cultivated in the same manner as in Example 3, except that the culture solution C for hydroponic cultivation of a fruit vegetable plant used in the cultivation was changed to the culture solution R for hydroponic cultivation of a fruit vegetable plant.

### <<Evaluation>>

### [Average Number of Fruits Harvested, Average Fruit Weight, and Average Yield]

Table 2 shows the average number of fruits harvested per plant, the average weight per fruit (average fruit weight), and the average weight (average yield) of fruits harvested per plant in Examples and Comparative Examples.

### [Brix Sugar Content]

The harvested tomato was cut into halves along any plane in the longitudinal direction (that is, a direction orthogonal to the equatorial plane), one of the divided halves (that is, ½ piece of the tomato) was crushed into a liquid (juice-like) state, and the sugar content was measured with a sugar content measuring instrument (sugar content meter manufactured by Atago Co., Ltd.) using the obtained fruit juice. The measurement was performed on all harvested tomatoes, and the average value of the measured values was defined as the Brix sugar content. The measurement results are shown in Table 2.

### [Si Content]

A part of a fruit juice obtained by crushing the fruit obtained in the average Brix sugar content measurement was dried and tableted to be used as a sample, and the Si content with respect to the dry mass of the tomato was measured by a fluorescence X-ray analysis method. The measurement was performed on all harvested tomatoes, and the average value of the measured values was defined as the Si content. The measurement results are shown in Table 2.

### [Lycopene Content]

A part of the fruit juice obtained by crushing the fruit obtained in the measurement of the average Brix sugar content was used to measure the lycopene content by a high-performance liquid chromatography method. The measurement results are shown in Table 2.

### [Sensory Evaluation]

In the above-described [Brix sugar content], another half of the harvested tomato cut into halves (that is, half piece of the tomato) along any plane in the longitudinal direction was used for sensory evaluation. 10 male and female subjects aged between 20 and 50 years were employed as evaluators to taste the tomato obtained in Examples and Comparative Examples, and to evaluate the taste on a 10-point scale (1 point to 10 points).

The tasting was performed using a fruit sample obtained by cutting a half piece of tomato into ⅛ pieces in a crescent shape, and the number of tastings by each evaluator was set to two or more.

In addition, the cultivation conditions were disclosed only for Comparative Example 1 for the evaluators, and the cultivation conditions were not disclosed for the other examples, and the score of the tomato of Comparative Example 1 was set to 5 points. All the evaluators sequentially tasted and evaluated all the fruit samples on the same day.

The evaluation results were not disclosed until all evaluators determined the scores, and the evaluators did not discuss anything with each other.

The average values of the scores are summarized in Table 2.

TABLE 2

| | | | Average | | | | | | |
|---|---|---|---|---|---|---|---|---|---|
| | Culture solution for hydroponic cultivation of | | number of | Average | | | | | |
| | fruit vegetable plant used in cultivation | | fruits | fruit | Average | Brix sugar | | Lycopene | |
| | Immediately after planting | After flowering | harvested | weight | yield | content | Si content | content | Sensory |
| | to before flowering of | of second fruit | [number/ | [g/ | [g/ | [% | [ppm | [mg/ | evaluation |
| | second fruit level | level | plant] | number] | plant] | by mass] | by mass] | 100 g] | [point] |
| Example 1 | A | A | 15.2 | 110 | 1,672 | 5.2 | 25 | 15.9 | 6 |
| Example 2 | B | B | 15.0 | 103 | 1,545 | 5.7 | 34 | 16.3 | 6.4 |
| Example 3 | N | C | 15.0 | 96 | 1,440 | 6.4 | 30 | 15.8 | 7.9 |
| Example 4 | N | D | 13.2 | 77 | 1,016 | 8.2 | 31 | 16.8 | 9.2 |
| Comparative | N | N | 12.0 | 105 | 1,260 | 4.8 | 0 | 15.9 | 5 |
| Example 1 | | | | | | | | | |
| Comparative | P | P | 12.2 | 102 | 1,244 | 5.0 | 19 | 15.8 | 5.1 |
| Example 2 | | | | | | | | | |
| Comparative | N | Q | 8.9 | 78 | 694 | 6.2 | 0 | 16.2 | 6.8 |
| Example 3 | | | | | | | | | |
| Comparative | N | R | 5.6 | 45 | 252 | 8.0 | 0 | 15.8 | 5.9 |
| Example 4 | | | | | | | | | |

The disclosure of JP2023-027721 filed on Feb. 24, 2023 is incorporated herein by reference in its entirety.

All documents, patent applications, and technical standards described in the present specification are incorporated herein by reference to the same extent as in a case of being specifically and individually noted that individual documents, patent applications, and technical standards are incorporated herein by reference.

What is claimed is:

1. A cultivation method for a fruit vegetable plant comprising:
cultivating a fruit vegetable plant by a hydroponic method using a culture solution having a Si content of 60 ppm by mass or more.

2. The cultivation method for a fruit vegetable plant according to claim 1,
wherein the culture solution contains a silicate.

3. The cultivation method for a fruit vegetable plant according to claim 1,
wherein the culture solution contains sodium chloride.

4. The cultivation method for a fruit vegetable plant according to claim 1,
wherein an electrical conductivity of the culture solution is 4.0 dS/m or more.

5. The cultivation method for a fruit vegetable plant according to claim 1,
wherein the cultivation of the fruit vegetable plant by the hydroponic method is performed at least after planting of a fruit vegetable plant seedling.

6. The cultivation method for a fruit vegetable plant according to claim 5, further comprising:
irradiating the fruit vegetable plant seedling with artificial light having an intensity of 200 μmol/m²/s to 800 μmol/m²/s.

7. The cultivation method for a fruit vegetable plant according to claim 6,
wherein the irradiation with the artificial light is performed from at least one of a side surface direction or an upper surface direction of the fruit vegetable plant.

8. The cultivation method for a fruit vegetable plant according to claim 1,
wherein the fruit vegetable plant is a tomato or a melon.

9. The cultivation method for a fruit vegetable plant according to claim 1,
wherein the fruit vegetable plant is a tomato, and
the tomato has a Si content of 20 ppm by mass or more with respect to a dry mass of the tomato.

10. The cultivation method for a fruit vegetable plant according to claim 1,
wherein the fruit vegetable plant is cultivated by a hydroponic method using a culture solution substantially free of Si after planting of a fruit vegetable plant seedling and until before flowering at a second fruit cluster level, and
after flowering at the second fruit cluster level, the fruit vegetable plant is cultivated by a hydroponic method using a culture solution having a Si content of 60 ppm by mass or more.

11. A tomato in which a Si content is 20 ppm by mass or more with respect to a dry mass of the tomato, and a Brix sugar content is 5.0% by mass or more.

12. A culture solution for hydroponic cultivation of a fruit vegetable plant, comprising:
sodium chloride; and
a silicate,
wherein a Si content is 60 ppm by mass or more.

13. The culture solution for hydroponic cultivation of a fruit vegetable plant according to claim 12,
wherein an electrical conductivity of the culture solution is 4.0 dS/m or more.

14. A hydroponic cultivation device of a fruit vegetable plant comprising:
a culture solution tank in which the culture solution for hydroponic cultivation of a fruit vegetable plant according to claim 12 is accommodated.
